(19) United States
(12) Patent Application Publication
(10) Pub. No.: US 2005/0201083 A1
(43) Pub. Date: Sep. 15, 2005

(54) Device for the recording and simultaneous representation of the conditions of a building

(76) Inventor: Eric Kuhn, Leipzig (DE)

Correspondence Address: LERNER AND GREENBERG, PA, P O BOX 2480, HOLLYWOOD, FL, 33022-2480, US

(21) Appl. No.: 11/076,753

(22) Filed: Mar. 10, 2005

(30) Foreign Application Priority Data
Mar. 10, 2004 (DE) 20 2004 003 723.8

(51) Int. Cl. F21V 19/04

(52) U.S. Cl. 362/147

(57) ABSTRACT

A device for the recording and simultaneously representing the conditions of a building is inserted into a cavity of the building to be inspected by exclusively using a cable. The device is guided by a gyroscopic unit which stabilizes the device elements recording the image data against the rotation of the exterior case about the upward ordinate axis.

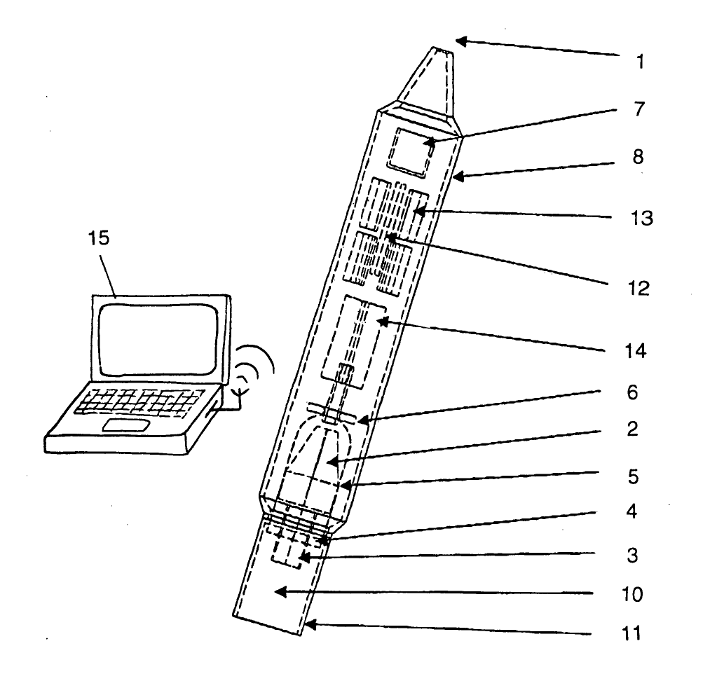

### BACKGROUND OF THE INVENTION

### FIELD OF THE INVENTION

The invention pertains to a device for insertion into a cavity to be inspected by exclusively using a cable for recording and simultaneously representing the conditions of a building.

It has been a general procedure to record and represent the conditions of a building by means of inspection with a camera. This has the disadvantage that the camera can be used only with the installation or plant switched off.

Another disadvantage is that such prior art devices are not provided with a measuring option.

It is also inconvenient that the representation of the conditions recorded was not possible in real time or close time-frames since the data recorded had to be transmitted and/or processed with suitable computer technology at first.

Special difficulties will arise from the prior art technique when data are to be acquired or recorded in vertical or inclined cavities which are subjected to flow and hot environmental temperatures of up to 150° C.

### SUMMARY OF THE INVENTION

It is accordingly an object of the invention to provide a device for detecting and concurrently displaying conditions of a building which overcomes the above-mentioned disadvantages of the heretofore-known devices and methods of this general type and which enables data to be recorded even in vertical or inclined cavities that are subjected to flow and hot environmental temperatures of up to 150° C.

With the foregoing and other objects in view there is provided, in accordance with the invention, a device for recording and representing conditions of a building, the device being configured for insertion into a cavity to be inspected exclusively with a cable. The device comprises:
a chassis defining a lower end and an upper end in a suspended operating position of the device;
a transparent dome, such as a glass dome, at the lower end in the suspended operating position;
at least one camera disposed at the transparent dome, at least one first laser associated with the camera for projecting a grid on the cavity, at least one second laser for measuring an object by depth and surface extension, and a lighting unit;
wherein the camera, the first laser, the second laser, and the lighting unit are disposed for common pivoting at a gyrated unit for stabilizing device elements recording image data against rotation of the chassis about a vertical axis.

In accordance with an added feature of the invention, an analysis unit disposed in the chassis for recording parameters of the surroundings of the device.

In accordance with an additional feature of the invention, a cooling unit is disposed in the chassis. Preferably, the cooling unit is formed with cascaded Peltier elements and/or with an internal air circulating system.

In accordance with another feature of the invention, a power supply unit formed of accumulators and elements for energy recycling from the Peltier elements of the cooling unit is provided. The power supply unit supplies electric energy to the device.

In accordance with a further feature of the invention, a data transfer unit is disposed in the chassis. The data transfer unit is configured to digitally transfer, by wireless transmission, recorded images and environmental data to a base station for display and evaluation. In a preferred embodiment, the base station is a personal computer, such as a desktop PC or a laptop PC, or the like.

In accordance with again an added feature of the invention, the chassis is formed of fiberglass-reinforced plastic material.

In accordance with a preferred embodiment, the chassis is formed with built-in air chambers.

In accordance with again an additional feature of the invention, the camera is pivotally disposed in the chassis for pivoting horizontally and at inclined angles.

In accordance with again another feature of the invention, the transparent dome is equipped with a heated screen. In accordance with again a further feature of the invention, the lighting unit is an LED lighting unit with a rating in accordance with a required lighting depth and lighting intensity. In an alternative embodiment, the lighting unit is a gas discharge lighting unit with a rating in accordance with a required lighting depth and lighting intensity.

In accordance with a concomitant feature of the invention, there is provided a base station for displaying the measuring data live through moving or fixed digital images in the image and/or opposite the image.

Other features which are considered as characteristic for the invention are set forth in the appended claims.

Although the invention is illustrated and described herein as embodied in a device for the recording and simultaneous representation of the conditions of a building, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE is a diagrammatic view of the device according to the invention.

### DESCRIPTION OF THE PREFERRED EMBODIMENT

Referring now to the sole FIGURE of the drawing in detail, the exemplary device 1 can be used in low-flow environmental atmospheres, such as stacks, chimneys, shafts, cavities (such as mines), the interiors of buildings out of service or, again, in restless atmospheres, such as chimneys under load. The device 1 is generally inserted into the space to be recorded with a winch.

The device 1 includes a chassis 8 or housing which can be preferably produced of fiberglass reinforced plastic material.

A special design of this form of the invention is provided with eight air chambers that are built into the chassis 8.

In its operating status, the device 1 is provided with a transparent dome, such as a glass dome 10, at its lower end through which a camera 2 arranged in the device 1 will record the image. The camera 2 is located in the chassis 8 to record optical information by pivoting horizontally and at inclined angles.

A minimum of one laser 3 is arranged at the head end of the camera 2.

The laser 3 is used for the projection of a grid onto the object to be recorded so that a 3-D effect is produced.

Another laser 4 installed at the head end of the camera 2 is used for measuring the object by depth and surface extension.

In order to ensure a consistently good image recording process when using the device 1 under different conditions, the glass dome 10 can be equipped with a heated screen 11 in a preferred embodiment or type of design of the invention.

The device elements for recording image data, namely, the camera 2, the lasers 3 and 4, as well as a lighting unit 5 that is pivotable with the camera 2, are mounted, as one single subassembly, in an electronic gyro unit 6 which stabilizes the device elements recording the image data against the rotation of the exterior case around the vertical, or upward ordinate axis.

A special embodiment of the novel configuration has LED or gas discharge technology for the lighting unit 5 which is to be graded according to the lighting depth and intensity required.

An analysis appliance 12 or analytic unit is disposed above the device elements 2, 3, 4 and 5 recording image data when the device is suspended under operating conditions.

The analytic unit 12 is used for the recording of environmental parameters with the device 1 in the cavity to be inspected, such as inside temperature, outside temperature, environmental pressure, air humidity, and gas composition.

It will be understood that other relevant data may be recorded. Such recording of other relevant data must also be considered to be part of the scope of protection for the invention.

As the device of the invention in its type of design described herein can be used up to temperature ranges of the order of 150° C., cooling will be required. The upper part of the device in its suspended condition during operation is therefore provided with a cooling unit 7.

This cooling unit 7 is preferably implemented as cascaded Peltier elements and supported by an internal air circulating system.

To supply electric energy to the device, a power supply unit 13 which is composed from accumulators is arranged below the cooling unit 7.

Further energy is supplied by energy recycled from the Peltier elements of power supply unit 13.

A data transfer unit 14 which digitally transfers by cordless and wireless transmission both the images recorded and the environmental data to a base station where they are represented and evaluated is located between cooling unit 7 and power supply unit 13.

This base station displays the measuring data through moving or fixed digital images live in the image and/or opposite the image.

The base station is usually a person computer, such as a PC or a laptop 15. The latter is illustrated as an example.

This application claims the priority, under 35 U.S.C. § 119, of German utility model No. 20 2004 003 723.8, filed Mar. 10, 2004; the entire disclosure of the prior application is herewith incorporated by reference.

1. A device for recording and representing conditions of a building, the device being configured for insertion into a cavity to be inspected exclusively with a cable, the device comprising:
a chassis defining a lower end and an upper end in a suspended operating position of the device;
a transparent dome at said lower end in the suspended operating position;
at least one camera disposed at said transparent dome, at least one first laser associated with said camera for projecting a grid on the cavity, at least one second laser for measuring an object by depth and surface extension, and a lighting unit;
wherein said camera, said first laser, said second laser, and said lighting unit are disposed for common pivoting at a gyrated unit for stabilizing device elements recording image data against rotation of said chassis about a vertical axis.

2. The device according to claim 1, wherein said transparent dome is a glass dome.

3. The device according to claim 1, which further comprises an analysis unit disposed in said chassis for recording parameters of an environment of the device.

4. The device according to claim 1, which further comprises a cooling unit disposed in said chassis.

5. The device according to claim 4, wherein said cooling unit is formed with cascaded Peltier elements.

6. The device according to claim 4, wherein said cooling unit is formed with an internal air circulating system.

7. The device according to claim 5, which further comprises a power supply unit formed of accumulators and elements for energy recycling from said Peltier elements of said cooling unit, said power supply unit supplying electric energy to the device.

8. The device according to claim 1, which further comprises a data transfer unit disposed in said chassis, said data transfer unit being configured to digitally transfer, by wireless transmission, recorded images and environmental data to a base station for display and evaluation.

9. The device according to claim 1, wherein said chassis is formed of fiberglass-reinforced plastic material.

10. The device according to claim 1, wherein said chassis is formed with built-in air chambers.

11. The device according to claim 1, wherein said camera is pivotally disposed in said chassis for pivoting horizontally and at inclined angles.

12. The device according to claim 1, wherein said transparent dome is equipped with a heated screen.

13. The device according to claim 1, wherein said lighting unit is an LED lighting unit with a rating in accordance with a required lighting depth and lighting intensity.

14. The device according to claim 1, wherein said lighting unit is a gas discharge lighting unit with a rating in accordance with a required lighting depth and lighting intensity.

15. The device according to claim 1, which comprises a base station for displaying the measuring data live through moving or fixed digital images in the image and/or opposite the image.
